(19) United States
(12) Patent Application Publication
(10) Pub. No.: US 2008/0113173 A1
(43) Pub. Date: May 15, 2008

(54) Polyvinyl Alcohol Film and Process for Producing the Same

(75) Inventors: Seiichirou Hayakawa, Osaka (JP); Katsuhiko Katsuma, Osaka (JP); Akihiko Chigami, Gifu (JP)

Correspondence Address: HAMRE, SCHUMANN, MUELLER & LARSON, P.C., P.O. BOX 2902, MINNEAPOLIS, MN, 55402-0902, US

(73) Assignee: The Nippon Synthetic Chemical Industry Co., Ltd., Osaka-shi (JP)

(21) Appl. No.: 11/666,774

(22) PCT Filed: Nov. 1, 2005
(86) PCT No.: PCT/JP05/20107

§ 371 Date: May 1, 2007

(30) Foreign Application Priority Data
Nov. 2, 2004 (JP) 2004-319264
Dec. 10, 2004 (JP) 2004-357945

(51) Int. Cl. B32B 27/30; C08J 5/18

(52) U.S. Cl. 428/220; 264/331.15

(57) ABSTRACT

The present invention provides a polyvinyl alcohol film having a film thickness of 30 to 70 μm and a kinetic friction coefficient against a stainless-steel roll of 0.03 or less and a process for producing a polyvinyl alcohol film.

### TECHNICAL FIELD

The present invention relates to a polyvinyl alcohol film. More specifically, it relates to a polyvinyl alcohol film excellent in conveying performance and having no optical defect and process for producing the same.

### BACKGROUND ART

Hitherto, a polyvinyl alcohol film has been produced by dissolving a polyvinyl alcohol-based resin in a solvent such as water to prepare a stock solution, subsequently forming a film by a solution-casting method (hereinafter, referred to as a casting method), and drying the film using a metal heating roll or the like. The polyvinyl alcohol film thus obtained has been utilized in a large number of applications as a film excellent in dyeing affinity and adsorptive property, and a polarizing film is cited as one of useful applications thereof. Such a polarizing film has been used as an elemental constituent element of liquid crystal displays and in recent years, its use has been extended to equipments for which high definition and high reliability are required.

Under such circumstances, as the screen size of a liquid crystal television set or the like is enlarged, size of the polarizing film, as a result, size of a polyvinyl alcohol film as a raw film thereof is also enlarged. For example, although the polyvinyl alcohol film having a width of 1 m was used until several years ago, one having a width of 2 m is a mainstream in these several years and a product having a width of 3 m or more already appears at present. Moreover, a roll having a length of 2000 m until several years is now lengthened to one having a length of 4000 m.

With such widening and lengthening, processes for producing such a polyvinyl alcohol film have been improved. There are many attempts not only to improve facilities but also to improve polymerization degree and crystallinity of the polyvinyl alcohol-based resin or water content of the film and to enhance handling ability of the film itself. For example, there have been proposed a method of defining water content in a film formation step of the polyvinyl alcohol film (see, e.g., Patent Document 1), a method of specifying a speed ratio between a winding apparatus and a cast drum to improve stretching property (see, e.g., Patent Document 2), a method of defining a static friction coefficient of a roll which comes into contact with the polyvinyl alcohol film (see, e.g., Patent Document 3), and the like.

However, even by these disclosed technologies, the production sometimes stagnates owing to cracks and wrinkles when the film is continuously conveyed in a roll-to-toll manner. Also, even when the polyvinyl alcohol film can be obtained, fine scratches are generated through rubbing between the roll and the film and thus linear optical defects sometimes become conspicuous at the production of the polarizing film. In particular, when a release powder is sprinkled over the surface of the product film in order to improve conveying ability and avoid blocking, the optical defects of the polarizing film are remarkably observed. Also in the production of the polyvinyl alcohol film and in the production of the polarizing film, continuous production has usually been carried out in a roll-to-roll manner and thus a large amount of labor is necessary for restoration of whole lines when the production is once stopped.

Therefore, in consideration of productivity, cost saving in recent years, and optical performance, further improvement in the process for producing the polyvinyl alcohol film has been desired.

### Patent Document 1: JP-A-2002-28938

### Patent Document 2: JP-A-2001-315141

### Patent Document 3: JP-A-2004-17321

### DISCLOSURE OF THE INVENTION

### Problems that the Invention is to Solve

An object of the invention is to provide a polyvinyl alcohol film capable of coping with widening and lengthening thereof, excellent in conveying performance, and having no optical defect, and a process for producing the same.

### Means for Solving the Problems

As a result of the extensive studies for solving the above problems, the present inventors have found that the above object can be achieved by the polyvinyl alcohol film and the process for producing the polyvinyl alcohol film shown in the following and thus they have accomplished the invention. Namely, the object of the invention has been achieved by the following polyvinyl alcohol film and process for producing the polyvinyl alcohol film.

(1) A polyvinyl alcohol film having a film thickness of 30 to 70 μm and a kinetic friction coefficient against a stainless-steel roll of 0.03 or less.

(2) The polyvinyl alcohol film according to the above (1), which comprises a polyvinyl alcohol-based resin having a weight-average molecular weight of 140000 to 260000.

(3) The polyvinyl alcohol film according to the above (1), which has a surface roughness (Ra) of 0.05 μm or less.

(4) The polyvinyl alcohol film according to the above (1), which has a film width of 2 m or more.

(5) The polyvinyl alcohol film according to the above (1), which has a film length of 4000 m or more.

(6) The polyvinyl alcohol film according to the above (1), which is used as a raw film for a polarizing film.

(7) A process for producing a polyvinyl alcohol film, which comprises:

(A) a step of preparing an aqueous polyvinyl alcohol-based resin solution containing a surfactant and having a water content of 60 to 90% by weight; and

(B) a step of producing a polyvinyl alcohol film having a water content of 5% by weight or less from the above aqueous polyvinyl alcohol-based resin solution by a casting method,

wherein the step of producing the polyvinyl alcohol film is carried out so that a vaporization rate of water in the above aqueous polyvinyl alcohol-based resin solution is from 15 to 30% by weight/minute.

(8). The process for producing a polyvinyl alcohol film according to the above (7), wherein the above surfactant is a surfactant containing nitrogen and the surfactant is contained in the above aqueous polyvinyl alcohol film solution in an amount of 0.01% by weight or more relative to the polyvinyl alcohol-based resin.

(9) The process for producing a polyvinyl alcohol film according to the above (7), wherein the above surfactant is a nonionic surfactant containing nitrogen.

(10) A process for producing a polyvinyl alcohol film, which comprises:

(A) a step of preparing an aqueous polyvinyl alcohol-based resin solution containing a surfactant and having a water content of 60 to 90% by weight; and

(B) a step of producing a polyvinyl alcohol film having a water content of 5% by weight or less from the above aqueous solution of the polyvinyl alcohol-based resin by a casting method,

wherein the step of producing the polyvinyl alcohol film is carried out so that a vaporization rate of the water in the aqueous solution of the polyvinyl alcohol-based resin is from 15 to 30% by weight/minute, and the above polyvinyl alcohol film is the polyvinyl alcohol film according to the above (1).

(11) The process for producing a polyvinyl alcohol film according to the above (10), wherein the above surfactant is a surfactant containing nitrogen and the surfactant is contained in the above aqueous polyvinyl alcohol film solution in an amount of 0.01% by weight or more relative to the polyvinyl alcohol-based resin.

(12) The process for producing a polyvinyl alcohol film according to the above (10), wherein the above surfactant is a nonionic surfactant containing nitrogen.

(13) A polarizing film formed of the polyvinyl alcohol film according to the above (1).

(14) A polarizing plate comprising: the polarizing film according to the above (13); and a protective film provided on at least one surface of the above polarizing film.

### ADVANTAGE OF THE INVENTION

Since the polyvinyl alcohol film of the invention has a small surface roughness and kinetic friction coefficient and thus a high sliding ability, the film is excellent in conveying ability. Moreover, the polyvinyl alcohol film of the invention is a polyvinyl alcohol film having no optical defect and is useful as a raw film for polarizing films.

### BEST MODE FOR CARRYING OUT THE INVENTION

The invention relates to a polyvinyl alcohol film having a film thickness of 30 to 70 μm and a kinetic friction coefficient against a stainless-steel roll of 0.03 or less.

As a polyvinyl alcohol-based resin for use in the polyvinyl alcohol film, there is usually employed a resin obtained by saponifying polyvinyl acetate derived from polymerization of vinyl acetate. However, in the invention, the resin is not necessarily limited thereto and use can be also made resins obtained by saponifying copolymers of vinyl acetate with a small amount of a component copolymerizable with vinyl acetate. As the component copolymerizable with vinyl acetate, for example, use can be made of unsaturated carboxylic acids and salts, esters, amides or nitriles thereof; olefins having 2 to 30 carbon atoms, such as ethylene, propylene, n-butene, and isobutene; vinyl ethers; unsaturated sulfonate salts; and the like.

Weight-average molecular weight of the polyvinyl alcohol-based resin is not particularly limited but is preferably from 120000 to 300000, more preferably from 140000 to 260000, more preferably from 160000 to 200000. When the weight-average molecular weight is less than 120000, sufficient optical performance is not obtained in the case where the polyvinyl alcohol film is used as an optical film. When the weight-average molecular weight exceeds 300000, stretching is difficult in the case where the film is used as a polarizing film and thus industrial production is difficult, so that the case is not preferred. Incidentally, the weight-average molecular weight of the polyvinyl alcohol-based resin means weight-average molecular weight measured by a GPC-LALLS method.

Moreover, saponification degree of the polyvinyl alcohol-based resin is preferably from 97 to 100% by mol, more preferably from 98 to 100% by mol, further preferably from 99 to 100% by mol. When the saponification degree is less than 97% by mol, sufficient optical performance is not obtained in the case where the polyvinyl alcohol-based resin is used as an optical film, so that the case is not preferred.

The process for producing the polyvinyl alcohol film of the invention is not particularly limited and, for example, it can be produced by the following process for producing a polyvinyl alcohol film according to the invention or the like process.

The process for producing a polyvinyl alcohol film according to the invention comprises:

(A) a step of preparing an aqueous polyvinyl alcohol-based resin solution containing a surfactant and having a water content of 60 to 90% by weight, and

(B) a step of producing a polyvinyl alcohol film having a water content of 5% by weight or less from the above aqueous polyvinyl alcohol-based resin solution by a casting method,

wherein the step of producing the polyvinyl alcohol film is carried out so that a vaporization rate of water in the aqueous polyvinyl alcohol-based resin solution is from 15 to 30% by weight/minute.

In the production process according to the invention, a surfactant is incorporated into the aqueous polyvinyl alcohol-based resin solution in order to enhance sliding ability of the film. As the surfactant, use can be made of a nonionic, anionic, or cationic surfactant usually used can be employed. The surfactant for use in the invention is preferably a surfactant containing nitrogen. Moreover, the surfactant for use in the invention is preferably a nonionic surfactant. In view of easiness of its localization at a surface layer part of the film after film formation, it is particularly preferable to use a nonionic surfactant containing nitrogen. Although a migration mechanism of the surfactant to the surface of the polyvinyl alcohol film in a drying step is not clear, it is presumed that the surfactant having high affinity with water may also migrate to the film surface as water migrates to the surface.

As the nonionic surfactant containing nitrogen, there may be mentioned a higher fatty acid monoalkanolamide represented by the formula (1):

R¹CONH—R²—OH (1),

a higher fatty acid dialkanolamide represented by the formula (2):

R¹CONH—(R²—OH)₂ (2),

a higher fatty acid amide represented by the formula (3):

R¹CONH₂ (3),

a polyoxyethylene-alkylamine represented by the formula (4):

R¹NH(C₂H₄O)ₓH (4)

or the formula (5):

H(C₂H₄O)_{y}N(R¹)(C₂H₄O)ₓH (5),

or the like. Moreover, in addition thereto, use can be made of a polyoxyethylene higher fatty acid amide, an amine oxide, or the like.

In the formulae (1) to (5), R¹ is an alkyl group or an alkenyl group having 6 to 22 carbon atoms, preferably 8 to 18 carbon atoms. When the carbon number of the alkyl group or alkenyl group is less than 6, hydrophobicity of the surfactant tends to be insufficient. When the carbon number exceeds 22, hydrophilicity of the surfactant tends to be insufficient. R² is any of —C₂H₅—, —C₃H₆—, or —C₄H₈—. When R² is other than these alkylene groups, hydrophilicity of the surfactant tends to be insufficient. Moreover, x and y each is an integer of 1 to 20, and x and y may be the same or different from each other. When at least one of x and y is an integer of 21 or more, compatibility of (aqueous polyvinyl alcohol-based resin solution) with (surfactant) tends to be poor. When such a surfactant is used, the alkyl group represented by R¹ may be single kind of alkyl group or may be a mixture of alkyl groups having different numbers of carbon atoms, such as alkyl groups derived from coconut oil, palm oil, palm kernel oil, or beef tallow.

As specific examples of the higher fatty acid alkanolamide, there may be mentioned caproic acid mono- or diethanolamide, caproic acid mono- or dipropanolamide, caproic acid mono- or dibutanolamide, caprylic acid mono- or diethanolamide, caprylic acid mono- or dipropanolamide, caprylic acid mono- or dibutanolamide, capric acid mono- or diethanolamide, capric acid mono- or dipropanolamide, capric acid mono- or dibutanolamide, lauric acid mono- or diethanolamide, lauric acid mono- or dipropanolamide, lauric acid mono- or dibutanolamide, palmitic acid mono- or diethanolamide, palmitic acid mono- or dipropanolamide, palmitic acid mono- or dibutanolamide, stearic acid mono- or diethanolamide, stearic acid mono- or dipropanolamide, stearic acid mono- or dibutanolamide, oleic acid mono- or diethanolamide, oleic acid mono- or dipropanolamide, oleic acid mono- or dibutanolamide, coconut oil fatty acid mono- or diethanolamide, coconut oil fatty acid mono- or dipropanolamide, coconut oil fatty mono- or dibutanolamide, and the like. Of these, lauric acid diethanolamide and coconut oil fatty acid diethanolamide are suitably used.

As specific examples of the higher fatty acid amide, there may be mentioned caproic acid amide, caprylic acid amide, capric acid amide, lauric acid amide, palmitic acid amide, stearic acid amide, oleic acid amide, and the like. Of these, palmitic acid amide and stearic acid amide are advantageously used.

As specific examples of the polyoxyethylene-alkylamine, there may be mentioned polyoxyethylene-hexylamine, polyoxyethylene-heptylamine, polyoxyethylene-octylamine, polyoxyethylene-nonylamine, polyoxyethylene-decylamine, polyoxyethylene-dodecylamine, polyoxyethylene-tetradecylamine, polyoxyethylene-hexadecylamine, polyoxyethylene-octadecylamine, polyoxyethylene-oleylamine, polyoxyethylene-eicosylamine, and the like. Of these, polyoxyethylene-dodecylamine is advantageously used.

As specific examples of the polyoxyethylene higher fatty acid amide, there may be mentioned polyoxyethylene caproic acid amide, polyoxyethylene caprylic acid amide, polyoxyethylene capric acid amide, polyoxyethylene lauric acid amide, polyoxyethylene palmitic acid amide, polyoxyethylene stearic acid amide, polyoxyethylene oleic acid amide, and the like. Of these, polyoxyethylene lauric acid amide and polyoxyethylene stearic acid amide are advantageously used.

As specific examples of the amine oxide, there may be mentioned dimethyllaurylamine oxide, dimethylstearylamine oxide, dihydroxyethyllaurylamine oxide, and the like. Of these, dimethyllaurylamine oxide is advantageously used.

Of the above surfactants containing nitrogen, polyoxyethylene-alkylamine, higher fatty acid amide, and the like are preferably used in view of compatibility of (aqueous polyvinyl alcohol-based resin solution) with (surfactant).

The amount of the surfactant to be added to the aqueous polyvinyl alcohol-based resin solution is preferably 0.01% by weight, further preferably from 0.01 to 3% by weight, more preferably from 0.03 to 2% by weight, particularly preferably from 0.05 to 1% by weight relative to the polyvinyl alcohol-based resin. When the amount of the surfactant to be added is less than 0.01% by weight, the amount of the surfactant in the vicinity of the surface of the film to be produced is insufficient and hence the advantages of the invention are poorly exhibited. To the contrary, when the amount of the surfactant to be added exceeds 3% by weight, surface appearance of the film becomes bad and hence the case is not preferred.

In the step (A), the method of preparing the aqueous polyvinyl alcohol-based resin solution is not particularly limited and the solution is prepared by a method of dissolving in water a polyvinyl alcohol-based resin wet cake obtained by adjusting the water content of the polyvinyl alcohol-based resin. It may be prepared using a multi-screw extruder or may be prepared by dissolving a hydrous polyvinyl alcohol-based resin wet cake in a dissolution tank equipped with vertically circulating flow type mixing impellers by introducing water vapor into the can.

In addition to the polyvinyl alcohol-based resin and the above surfactant, in view of mechanical properties and productivity, it is preferable to incorporate a commonly used plasticizer such as glycerin, diglycerin, triglycerin, ethylene glycol, triethylene glycol, or polyethylene glycol into the aqueous polyvinyl alcohol-based resin solution, if necessary. The amount of the plasticizer to be added is preferably 30% by weight or less, more preferably from 3 to 25% by weight, further preferably from 5 to 20% by weight relative to the polyvinyl alcohol-based resin. When the amount to be added exceeds 30% by weight, strength of the film produced is poor and hence the case is not preferred.

The water content (water content a to be mentioned below) of the aqueous polyvinyl alcohol-based resin solution thus obtained for use in the invention is from 60 to 90% by weight (resin concentration of 40 to 10% by weight), preferably from 65 to 85% by weight (resin concentration of 35 to 15% by weight), particularly preferably from 70 to 80% by weight (resin concentration of 30 to 20% by weight). When the water content is less than 60% by weight, the viscosity of the aqueous solution is too high and thus homogeneous dissolution is difficult. To the contrary, when the water content exceeds 90% by weight, a lot of time is required for vaporization of the water and hence the case is poor in productivity.

Into the aqueous polyvinyl alcohol-based resin solution, in order to control the vaporization rate of water in the drying step, a small amount of an auxiliary solvent may be incorporated in the range of 30 parts by weight or less relative to 100 parts by weight of water. The auxiliary solvent is preferably a water-soluble solvent and use can be made of methanol, ethanol, ethylene glycol, propylene glycol, diethylene glycol, triethylene glycol, tetraethylene glycol, trimethylolpropane, dimethyl sulfoxide, N-methylpyrrolidone, ethylenediamine, diethylenetriamine, and a mixture thereof.

Then, the aqueous polyvinyl alcohol-based resin solution prepared in the step (A) is usually subjected to a defoaming treatment. As the defoaming method, there may be mentioned methods of defoaming on standing, defoaming by means of a multi-screw extruder, and the like. The multi-screw extruder is not particularly limited so far as it is a multi-screw extruder with bent but usually, a twin-screw extruder with bent is used.

After the defoaming treatment, the aqueous polyvinyl alcohol-based resin solution is introduced into a T-form slit die a specific amount by a specific amount. Thereafter, the aqueous polyvinyl alcohol-based resin solution ejected from the slit die is cast on a drum roll or an endless belt and a film formed by a casting method is dried to form a film having a water content of 5% by weight or less (step (B)).

At the casting of the aqueous polyvinyl alcohol-based resin solution, a drum roll or an endless belt are commonly used but a drum roll is preferably used in view of widening, lengthening, uniformity of film thickness, and the like.

In the production process according to the invention, the vaporization rate of water in the aqueous polyvinyl alcohol-based resin solution is controlled so as to be from 15 to 30% by weight/minute. The vaporization rate herein is a value (% by weight/minute) represented by the following equation wherein the water content of the aqueous polyvinyl alcohol-based resin solution prepared in the step (A) is represented by a (% by weight), the water content of the film after drying is represented by b (% by weight), and a period of time from the time point at which the aqueous polyvinyl alcohol-based resin solution is ejected onto the drum roll to the time point at which drying of the film is finished is represented by T (minute).

Vaporization rate=(a−b)/Y

In the production process according to the invention, the vaporization rate is controlled so as to be from 15 to 30% by weight/minute, preferably from 18 to 27% by weight/minute, more preferably from 20 to 25% by weight/minute. It seems that faster vaporization rate may result in effective migration of the surfactant to the vicinity of surface of the film without diffusing and leaving the surfactant in the produced film. When the vaporization rate is less than 15% by weight/minute, the migration of the surfactant to the film surface is not sufficient and hence an improving effect on sliding ability is not enough. To the contrary, when the vaporization rate exceeds 30% by weight/minute, bleed-out of the surfactant occurs, so that surface smoothness of the film may decrease and deterioration of film appearance such as whitening may occur. When a sufficient amount of the surfactant migrates to the vicinity of the surface of the film, there is enhanced sliding ability between the film surface and a metal roll mainly made of stainless steel (hereinafter referred to as SUS) for use in each step in the production of the film or the polarizing film, so that scratching on the film surface induced by the contact with the metal roll may disappear.

The water content b of the polyvinyl alcohol film after drying is 5% by weight or less, preferably 4% by weight or less, more preferably 3% by weight or less. Moreover, a lower limit of the water content b is preferably (0.5% by weight) or more. When the water content exceeds 5% by weight, drying is insufficient, so that wrinkles and the like tend to be generated.

In the invention, the water content b of the polyvinyl alcohol film after drying is measured as follows. Namely, a film having a size of 15 cm×15 cm is prepared as a sample film and weight (before drying under reduced pressure) of the present sample film is measured. The thickness of the sample film is not particularly limited so far as it is from 30 to 70 μm. Then, the present sample film is dried under reduced pressure at 83° C. in a vacuum drier (degree of vacuum: 10 mmHg or less) and weight of the sample film after drying under reduced pressure is measured. From the weight of the sample film before and after drying under reduced pressure, the water content b is calculated in accordance with the following equation.

Water content b(%)={(film weight before drying under reduced pressure)−(film weight after drying under reduced pressure)}×100/(film weight before drying under reduced pressure)

The vaporization rate is controlled in the film-forming step and drying step. The vaporization rate in the film-forming step is mainly determined by surface temperature of the drum roll and contact time of the aqueous polyvinyl alcohol-based resin solution with the drum roll but vaporization may be accelerated by blowing of hot air. The surface temperature of the drum roll is preferably from 70 to 100° C., more preferably from 80 to 95° C., further preferably from 85 to 95° C. When the temperature is less than 70° C., productivity is poor and when the temperature exceeds 100° C., bubbles form in the polyvinyl alcohol-based resin film. The contact time is preferably from 30 to 240 seconds, more preferably from 40 to 180 seconds, further preferably from 50 to 120 seconds. When the contact time is less than 30 seconds, wrinkles are apt to be generated in the drying step. When the time exceeds 240 seconds, productivity is poor and hence the case is not preferred.

The procedure for drying to be conducted after film formation is not particularly limited and there may be mentioned a method of drying using plurality of hot rolls, a method of drying with a floating dryer, and the like. The drying temperature and drying time are not particularly limited so far as the vaporization rate of water is from 15 to 30% by weight/minute but the drying temperature is preferably in the range of 50 to 150° C.

In the invention, a kinetic friction coefficient of the resulting polyvinyl alcohol film against a stainless-steel roll is 0.03 or less, preferably from 0.01 to 0.03, particularly preferably from 0.02 to 0.03. In the invention, the kinetic friction coefficient μ of the film against a stainless-steel roll is a rolling friction coefficient calculated from the following equation based on driving force F (kgf) when a test roll of SUS 304 having a width of 40 mm, a diameter of 80 mm, a weight of 2.0 kg, and a surface roughness (Ra) of 0.05 μm is rolled on the film at a rate of 100 mm/minute.

μ=F/2.0

When the kinetic friction coefficient is 0.03 or less, cracks and wrinkles are not generated and conveyed with good productivity at the conveying of the film through rolls made of SUS in a roll-to-roll manner and further, a polyvinyl alcohol film having no optical defect can be obtained.

In the invention, the surface roughness (Ra) is an arithmetic average roughness in accordance with JIS B0601 and the surface roughness (Ra) of the test roll of 0.05 μm is a value for a roll used for conveying and winding common optical films.

Moreover, the polyvinyl alcohol film of the invention has a surface roughness (Ra) of preferably 0.05 μm or less, further preferably 0.03 μm or less, particularly preferably 0.01 to 0.02 μm. When the surface roughness (Ra) exceeds 0.05 μm, light scattering occurs on the film surface and hence the case is not preferred.

Light transmittance of the polyvinyl alcohol film of the invention is preferably 90% or more, more preferably 91% or more. An upper limit of the light transmittance is 95%.

Tensile strength of the polyvinyl alcohol film of the invention is preferably 70 N/mm² or more, more preferably 75 N/mm² or more. Moreover, an upper limit of the tensile strength is preferably 115 N/mm² or less, more preferably 110 N/mm² or less. In this connection, the tensile strength in the invention is tensile strength obtained by subjecting a test piece whose moisture is controlled under an environment of 20° C. and 65% RH to a tensile test at a tensile rate of 1000 mm/min under the same environment.

Complete dissolution temperature of the polyvinyl alcohol film of the invention is preferably 65° C. or higher, further preferably from 65 to 90° C., more preferably from 71 to 80° C. In this connection, the complete dissolution temperature in the invention is a temperature at which the film is completely dissolved at the time when 2000 ml of water is placed in a 2 L beaker and is elevated to a temperature of 30° C., then a film piece of 2 cm×2 cm is charged, and the water temperature is elevated at a rate of 3° C./minute under stirring. The thickness of the film piece is not particularly limited so far as it is 30 to 70 μm.

Furthermore, the polyvinyl alcohol film of the invention has a thickness of 30 to 70 μm, preferably 35 to 55 μm, particularly preferably 40 to 50 μm. When the thickness is less than 30 μm, stretching is difficult and also sufficient polarizing performance is not obtained in the case where the film is used as a polarizing film. When the thickness exceeds 70 μm, at the time when a polarizing film is produced using such a film and the resulting film is attached to a liquid crystal panel, inconveniences such as aptness to generate whitening with time and deterioration in display quality of the panel are apt to occur.

In the polyvinyl alcohol film of the invention, width and length thereof are optional but, in consideration of the trend of widening and lengthening in recent years, the width is preferably 2 m or more, further preferably 2.5 m or more, particularly preferably 3 m or more and the length is preferably 1000 m or more, further preferably from 2000 m or more, particularly preferably 3000 m or more. In view of productivity of the polarizing film, the length is particularly preferably 4000 m or more, further preferably from 4000 to 15000 m. When the width is less than 2 m or the length is less than 1000 m, productivity of the polarizing film is poor.

The polyvinyl alcohol film of the invention has smoothness and appearance sufficient as an optical film and thus is preferably used as a raw film for optical uses, particularly production of polarizing films. Film thickness of the polyvinyl alcohol film for use in the production of the polarizing films is from 30 to 70 μm as described above, preferably from 35 to 55 μm, particularly preferably from 40 to 50 μm.

The polarizing film of the invention is produced via steps of usual dyeing, stretching, crosslinking with boric acid, and thermal treatment using the above polyvinyl alcohol film. As a process for producing the polarizing film, there are a method of stretching of the polyvinyl alcohol film, dyeing by dipping it in a solution of iodine or a dichroic dye, and subsequently treatment with a boron compound, a method of simultaneous stretching and dyeing and subsequent treatment with a boron compound, a method of dyeing with iodine or a dichroic dye and stretching and subsequent treatment with a boron compound, a method of dyeing and subsequent stretching in a solution of a boron compound, and the like method, which can be suitably selected and used. Thus, the polyvinyl alcohol film (unstretched film) may be subjected to stretching, dyeing, and further treatment with a boron compound separately or simultaneously. However, in view of productivity, it is desirable to carry out uniaxial stretching during at least one step of the dyeing step and the step of treatment with a boron compound.

The stretching is desirably conducted at a magnification of 3 to 10 times, preferably 3.5 to 6 times in a uniaxial direction. On this occasion, it is also possible to slightly stretch in a direction perpendicular to the stretching direction (stretching of a degree so as to prevent shrinkage in a width direction or more degree). The temperature at stretching is desirably selected from 40 to 170° C. Furthermore, stretching magnification may be finally set within the above range and the stretching operation may be carried out not only at one stage but also at any stages in the production steps.

The dyeing of the film is generally carried out by bringing the film into contact with a liquid containing iodine or a dichroic dye. Usually, an aqueous solution of iodine-potassium iodide is used and it is preferable that concentration of iodine is from 0.1 to 20 g/L, concentration of potassium iodide is from 10 to 70 g/L, a weight ratio of potassium iodide/iodine is from 10 to 100. Dyeing time is practically from about 30 to 500 seconds. Temperature of the treating bath is preferably from 5 to 60° C. Into the aqueous solution, it is possible to incorporate an organic solvent compatible with water in addition to water solvent. As a means for the contact, any means such as dipping, applying, and spraying can be applied.

The film subjected to the dyeing treatment is generally treated with a boron compound. As the boron compound, boric acid or borax is practical. The boron compound is preferably used in a form of an aqueous solution or a mixed solution of water-organic solvent in a concentration of about 0.3 to 2 mol/L. In the solution, coexistence of a small amount of potassium iodide is practically desired. A dipping method is desirable as the treating method but an applying method or a spraying method is also practicable. Temperature at the treatment is preferably about 40 to 70° C. and treating time is preferably from about 2 to 20 minutes. Moreover, if necessary, a stretching operation may be conducted during the treatment.

A polarization degree of the polarizing film of the invention thus obtained is preferably from 98 to 99.9%, more preferably from 99 to 99.9%. When the polarization degree is less than 98%, contrast of display with liquid crystals reduces and hence the case is not preferred.

Moreover, single transmittance of the polarizing film of the invention is preferably 43% or more. When the transmittance is less than 43%, there is a tendency that high luminance of a liquid crystal display cannot be achieved. In this connection, an upper limit of the single transmittance of the polarizing film is 46%.

The polarizing film of the invention can be used as a polarizing plate having a protective film on one surface or both surfaces thereof. The protective film is preferably an optically isotropic polymer film or polymer sheet. As the protective film, there may be, for example, mentioned a film or sheet of cellulose triacetate, cellulose diacetate, polycarbonate, polymethyl methacrylate, polystyrene, a polyether sulfone, a polyarylene ester, poly-4-methylpentene, polyphenylene oxide, a cyclo-type polyolefin, or a norbornene-based polyolefin.

Moreover, onto the polarizing film, for the purpose of thinning the film, instead of the above protective film, it is also possible to apply a curable resin such as a urethane-based resin, acrylic resin, or a urea resin on one surface or both surfaces thereof to effect lamination.

The polarizing film (inclusive of the film having a protective film or a curable resin laminated on at least one surface) is sometimes put into a practical use after formation of a transparent pressure-sensitive adhesive layer on one surface thereof, if necessary, by a method commonly known. As the pressure-sensitive adhesive layer, particularly preferred is one mainly comprising a copolymer of an acrylate ester such as butyl acrylate, ethyl acrylate, methyl acrylate, or 2-ethylhexyl acrylate with an α-monoolefinic carboxylic acid such as acrylic acid, maleic acid, itaconic acid, methacrylic acid, or crotonic acid (inclusive of a copolymer wherein a vinyl monomer such as acrylronitrile, vinyl acetate, or styrene is added) since polarizing properties of the polarizing film are not inhibited. However, any pressure-sensitive adhesive having transparency can be used without limitation thereto and polyvinyl ether-based one or rubber-based one may be used.

Moreover, it is possible to provide various functional layers on one surface (surface having no above pressure-sensitive adhesive) of the polarizing film (one having the above pressure-sensitive adhesive). As the functional layers, there may be mentioned an antiglare layer, a hard coat layer, an antireflection layer, a half reflection layer, a reflection layer, a phosphorescent layer, a diffusion layer, an electroluminescence layer, a view angle-enlarging layer, a luminescence-improving layer, and the like. Furthermore, it is also possible to combine two or more of the layers. For example, there may be mentioned combinations such as an antiglare layer and an antireflection layer, a phosphorescent layer and a reflection layer, a phosphorescent layer and a half reflection layer, a phosphorescent layer and a light diffusion layer, a phosphorescent layer and an electroluminescence layer, and a half reflection layer and an electroluminescence layer. However, the functional layer is not limited thereto.

The polarizing film of the invention is preferably used in electronic desk calculators, electronic clocks or watches, word processors, personal computers, handy information terminals, liquid crystal display devices such as instruments for automobiles and machines, sunglasses, eye-protective glasses, 3D glasses, reflection-reducing layers for display devices (CRT, LCD, etc.), medical equipments, building materials, toys, and the like.

### EXAMPLES

The following will describe embodiments of the invention with reference to Examples but the invention is not limited to these Examples.

In Examples, weight-average molecular weight of a polyvinyl alcohol-based resin, a kinetic friction coefficient between a polyvinyl alcohol film and a stainless-steel roll, and surface roughness Ra of the polyvinyl alcohol film were determined by the following methods.

### (1) Weight-Average Molecular Weight

Weight-average molecular weight is measured under the following conditions by a GPC-LALLS method.

### 1) GPC

### Apparatus: 244 type gel permeation chromatograph manufactured by Waters

### Column: TSK-gel-GMPWXL manufactured by Tosoh Corporation (inner diameter of 8 mm, length of 30 cm, two columns)

### Solvent: 0.1M Tris buffer solution (pH 7.9)

Flow rate: 0.5 ml/minute

### Temperature: 23° C.

Sample concentration: 0.040%

### Filtration: 0.45 μm MAISHORI Disk W-25-5 manufactured by Tosoh Corporation

Injection amount: 0.2 ml

### Detection sensitivity (differential refractometer detector): 4 magnifications

### 2) LALLS

### Apparatus: KMX-6 type low angle laser light scattering photometer manufactured by Chromatrix

### Temperature: 23° C.

### Wavelength: 633 nm

### Second virial coefficient × concentration: 0 mol/g

### Refractive index change (dn/dc): 0.159 ml/g

### Filter: 0.45 μm filter HAWP01300 manufactured by MILLIPORE

### Gain: 800 mV

### (2) Kinetic Friction Coefficient

After a strip test piece having a width of 40 mm and a length of 100 mm is left under the environment of 23° C. and 50% RH for 1 day, it is placed on a flat table, and a roll made of SUS 304 having a width of 40 mm, a diameter of 80 mm, a weight of 2.0 kg, and a surface roughness Ra of 0.05 μm is rolled on the test piece at a rate of 100 mm/minute in a distance of 70 mm. Driving force (kgf) at that time is measured on an autograph AGS-H manufactured by Shimadzu Corporation and a kinetic friction coefficient μ is determined in accordance with the following equation.

μ=F/2.0

### (3) Surface Roughness (Ra)

It is measured using a laser focus microscope VK-8500 manufactured by Keyence Corporation. Measuring conditions are as follows.

Measuring length: 0.3 mm, Objective lens: 50 magnifications, Cut-off: 0.8 μm, Smoothing: none

### Example 1

### Production of Polyvinyl Alcohol Film

Water (200 kg) at 18° C. was placed in a 500 L tank and 40 kg of a polyvinyl alcohol-based resin having a weight-average molecular weight of 142000 and a saponification degree of 99.8% by mol was added thereto, followed by stirring for 15 minutes. Then, after water was once discharged, 200 kg of water was further added and the whole was stirred for 15 minutes. The resulting slurry was subjected to water removal, whereby a polyvinyl alcohol-based resin wet cake having a water content of 40% by weight was obtained.

The resulting polyvinyl alcohol-based resin wet cake (67 kg) was placed in a dissolution tank, and 4.2 kg of glycerin as a plasticizer, 28 g of polyoxyethylene-alkylamine (R¹ is C₁₂H₂₅ and x and y are each 1 in the formula (5)), and 10 kg of water were added thereto, followed by introduction of water vapor from the bottom of the can. Stirring (number of rotation: 5 rpm) was started at the time when inner resin temperature reached 50° C. and the inner system was pressurized at the time when inner resin temperature reached 100° C. After the temperature was elevated to 150° C., the introduction of water vapor was stopped (introduced amount of water vapor was 90 kg in total) and the whole was stirred for 30 minutes (number of rotation: 20 rpm). After homogeneously dissolved, an aqueous polyvinyl alcohol-based resin solution having a water content of 74% by weight was obtained.

Then, after the resulting aqueous polyvinyl alcohol-based resin solution (liquid temperature of 147° C.) was subjected to defoaming in a twin-screw extruder, the solution was ejected from a T-type slit die (straight manifold die) onto a drum roll (liquid temperature of 95° C.) and was cast to form a film. The casting conditions are as follows.

### Drum Roll

Diameter: 3200 mm, Width: 4000 mm, Rotation rate: 10 m/minute, Surface temperature: 95° C., Contact time: 54 seconds

The resulting film immediately after casting had a water content of 20% by weight. The film was continuously dried at 100° C. for 111 seconds by means of a floating dryer (length of 18.5 m) which achieved blowing of hot air from both sides of the film. The resulting polyvinyl alcohol film (width of 3000 mm, thickness of 50 μm, length of 4000 m) had a water content of 4% by weight and time required from ejection to completion of drying was 165 seconds (vaporization rate of water: 25% by weight/minute).

The kinetic friction coefficient of the resulting film was 0.021 and the surface roughness (Ra) was 0.03 μm.

### Production of Polarizing Film

The resulting polyvinyl alcohol film was dipped in an aqueous solution composed of 0.2 g/L of iodine and 15 g/L of potassium iodide at 30° C. for 240 seconds and then was dipped in an aqueous solution (55° C.) having a composition of 60 g/L of boric acid and 30 g/L of potassium iodide to perform treatment with boric acid over a period of 5 minutes with simultaneous uniaxial stretching of 4 magnifications. Thereafter, the film was dried to obtain a polarizing film. Optical defects of the resulting polarizing film were evaluated as follows. The results are shown in Table 2.

### Optical Defects

Optical linear defects on the surface of the polarizing film were observed using a light box having a surface illumination of 14000 lux and the film was evaluated in accordance with the following standards.

### O . . . absence of defects

### X . . . presence of defects

### Examples 2 to 5

Polyvinyl alcohol films were obtained in the same manner as in Example 1 with the exception of the conditions shown in Table 1. The kinetic friction coefficient and surface roughness of each of the resulting films are shown in Table 2.

Moreover, polarizing films were obtained in the same manner as in Example 1 and were evaluated in the same manner as in Example 1. The results are shown in Table 2.

### Example 6

A polyvinyl alcohol film was obtained in the same manner as in Example 1 with the exception that a polyvinyl alcohol-based resin having a weight-average molecular weight of 175000 was used. A kinetic friction coefficient and surface roughness of the resulting film are shown in Table 2.

Moreover, a polarizing film was obtained in the same manner as in Example 1 and was evaluated in the same manner as in Example 1. The results are shown in Table 2.

### Comparative Examples 1 and 2

Polyvinyl alcohol films were obtained in the same manner as in Example 1 with the exception of the conditions shown in Table 1. The kinetic friction coefficient and surface roughness of each of the resulting films are shown in Table 2.

Moreover, polarizing films were obtained in the same manner as in Example 1 and were evaluated in the same manner as in Example 1. The results are shown in Table 2.

### Comparative Example 3

A polyvinyl alcohol film was obtained in the same manner as in Example 1 with the exception of the conditions shown in Table 1. However, a surfactant was precipitated on the film surface and film appearance was whitened, so that a film worthy to evaluate was not obtained.

TABLE 1

| | Water | | | | | | | | |
|---|---|---|---|---|---|---|---|---|---|
| | content | | | | | | | | |
| | of | | | | | | | | |
| | aqueous | | Roll rotation | Contact | | | | Time required from | Vaporization |
| | solution | Roll | rate | time with | Water content | Drying | Final water | ejection to | rate of water |
| | (% by | temperature | (m/ | roll | after casting | conditions | content (% by | completion of | (% by |
| | weight) | (° C.) | minute) | (second) | (% by weight) | (° C./second) | weight) | drying (second) | weight/minute) |
| Example 1 | 74 | 95 | 10 | 54 | 20 | 100/111 | 4 | 165 | 25 |
| Example 2 | 74 | 90 | 8 | 68 | 21 | 100/122 | 4 | 190 | 22 |
| Example 3 | 74 | 85 | 6 | 90 | 25 | 100/180 | 5 | 270 | 15 |
| Example 4 | 65 | 90 | 8 | 68 | 16 | 100/122 | 3 | 190 | 20 |
| Example 5 | 85 | 90 | 8 | 68 | 25 | 100/202 | 4 | 270 | 18 |
| Example 6 | 74 | 95 | 10 | 54 | 21 | 100/111 | 4 | 165 | 25 |
| Comparative | 74 | 70 | 6 | 90 | 32 | 100/330 | 5 | 420 | 10 |
| Example 1 | | | | | | | | | |
| Comparative | 65 | 90 | 6 | 90 | 15 | 100/180 | 3 | 270 | 14 |
| Example 2 | | | | | | | | | |
| Comparative | 74 | 100 | 10 | 54 | 13 | 110/74 | 4 | 128 | 33 |
| Example 3 | | | | | | | | | |

TABLE 2

| | Polyvinyl alcohol film | | |
|---|---|---|---|
| | Kinetic friction | Surface roughness | Polarizing film |
| | coefficient | Ra (μm) | Optical defect |
| Example 1 | 0.021 | 0.03 | ◯ |
| Example 2 | 0.024 | 0.02 | ◯ |
| Example 3 | 0.028 | 0.02 | ◯ |
| Example 4 | 0.023 | 0.02 | ◯ |
| Example 5 | 0.029 | 0.02 | ◯ |
| Example 6 | 0.020 | 0.03 | ◯ |
| Comparative | 0.045 | 0.02 | X |
| Example 1 | | | |
| Comparative | 0.031 | 0.02 | X |
| Example 2 | | | |
| Comparative | — | — | — |
| Example 3 | | | |

While the invention has been described in detail and with reference to specific examples thereof, it will be apparent to one skilled in the art that various changes and modifications can be made therein without departing from the spirit and scope thereof.

The present application is based on Japanese Patent Application No. 2004-319264 filed on Nov. 2, 2004 and Japanese Patent Application No. 2004-357945 filed on Dec. 10, 2004, and the contents are incorporated herein by reference.

### INDUSTRIAL APPLICABILITY

According to the present invention, a polyvinyl alcohol film excellent in conveying performance and having no optical defect can be obtained. Moreover, the polyvinyl alcohol film of the invention is a polyvinyl alcohol film having no optical defect and is useful as a raw film for polarizing films.

1. A polyvinyl alcohol film having a film thickness of 30 to 70 μm and a kinetic friction coefficient against a stainless-steel roll of 0.03 or less.

2. The polyvinyl alcohol film according to claim 1, which comprises a polyvinyl alcohol-based resin having a weight-average molecular weight of 140000 to 260000.

3. The polyvinyl alcohol film according to claim 1, which has a surface roughness (Ra) of 0.05 μm or less.

4. The polyvinyl alcohol film according to claim 1, which has a film width of 2 m or more.

5. The polyvinyl alcohol film according to claim 1, which has a film length of 4000 m or more.

6. The polyvinyl alcohol film according to claim 1, which is used as a raw film for a polarizing film.

7. A process for producing a polyvinyl alcohol film, which comprises:
(A) a step of preparing an aqueous polyvinyl alcohol-based resin solution containing a surfactant and having a water content of 60 to 90% by weight; and
(B) a step of producing a polyvinyl alcohol film having a water content of 5% by weight or less from the above aqueous polyvinyl alcohol-based resin solution by a casting method,
wherein the step of producing the polyvinyl alcohol film is carried out so that a vaporization rate of water in the above aqueous polyvinyl alcohol-based resin solution is from 15 to 30% by weight/minute.

8. The process for producing a polyvinyl alcohol film according to claim 7, wherein the above surfactant is a surfactant containing nitrogen and the surfactant is contained in the above aqueous polyvinyl alcohol film solution in an amount of 0.01% by weight or more relative to the polyvinyl alcohol-based resin.

9. The process for producing a polyvinyl alcohol film according to claim 7, wherein the above surfactant is a nonionic surfactant containing nitrogen.

10. A process for producing a polyvinyl alcohol film, which comprises:
(A) a step of preparing an aqueous polyvinyl alcohol-based resin solution containing a surfactant and having a water content of 60 to 90% by weight; and
(B) a step of producing a polyvinyl alcohol film having a water content of 5% by weight or less from the above aqueous solution of the polyvinyl alcohol-based resin by a casting method,
wherein the step of producing the polyvinyl alcohol film is carried out so that a vaporization rate of the water in the aqueous solution of the polyvinyl alcohol-based resin is from 15 to 30% by weight/minute, and the above polyvinyl alcohol film is the polyvinyl alcohol film according to claim 1.

11. The process for producing a polyvinyl alcohol film according to claim 10, wherein the above surfactant is a surfactant containing nitrogen and the surfactant is contained in the above aqueous polyvinyl alcohol film solution in an amount of 0.01% by weight or more relative to the polyvinyl alcohol-based resin.

12. The process for producing a polyvinyl alcohol film according to claim 10, wherein the above surfactant is a nonionic surfactant containing nitrogen.

13. A polarizing film formed of the polyvinyl alcohol film according to claim 1.

14. A polarizing plate comprising: the polarizing film according to claim 13; and a protective film provided on at least one surface of the above polarizing film.
